(19) United States
(12) Patent Application Publication
(10) Pub. No.: US 2006/0197707 A1
(43) Pub. Date: Sep. 7, 2006

(54) External antenna device and electronic device using the same

(75) Inventors: Chu-Chia Tsai, Taipei (TW); Chia-Hsien Lee, Taipei (TW)

Correspondence Address: QUINTERO LAW OFFICE, 1617 BROADWAY, 3RD FLOOR, SANTA MONICA, CA, 90404, US

(73) Assignee: WISTRON CORP., TAIPEI HSIEN (TW)

(21) Appl. No.: 11/190,446

(22) Filed: Jul. 27, 2005

(30) Foreign Application Priority Data
Mar. 3, 2005 (TW) TW94203260

(51) Int. Cl. H01Q 1/24

(52) U.S. Cl. 343/702

(57) ABSTRACT

An external antenna device comprises an antenna, a low noise amplifier device, a first connection part and a second connection part. The antenna is operable for receiving radio signals. The low noise amplifier device electrically connected to the antenna is operable for receiving the radio signals and outputting first signals. The first connection part electrically connected to the low noise amplifier device and an electronic device is operable for transmitting power provided by the electronic device to the low noise amplifier device. The second connection part electrically connected to the low noise amplifier device and the electronic device is operable for transmitting the first signal to the electronic device.

### BACKGROUND

The invention relates to an antenna device and more particularly to an external antenna device for an electronic device.

In the past, an external TV box was required to receive TV signals via a notebook computer. Currently, the manufacturers embed a TV module in a notebook computer or integrate the TV module into a TV module card for a specific slot of notebook computer with such a module only an antenna device is required to receive TV signals. FIG. 1A is a schematic diagram illustrating an electronic device using a passive antenna. According to FIG. 1A, light passive antenna 13 can be used for an electronic device such as a notebook computer 14 to eliminate the need to carry a separate TV box. The low sensitivity of the passive antenna 13, however offer low quality reception of radio signals such as TV and digital TV signals to the notebook computer 14. FIG. 1B is a schematic diagram illustrating an electronic device using an active antenna. According to FIG. 1B, the quality of radio signal received by the active antenna 16 for the notebook computer 15 is improved. The active antenna however requires an additional power supply, such as a transformer 17, thus increasing the inconvenience.

### SUMMARY

The invention provides an external antenna device and an electronic device using the same.

An external antenna device according to one aspect of the invention comprises an antenna, a low noise amplifier device, a first connection part and a second connection part. The antenna is operable for receiving radio signals. The low noise amplifier device electrically connected to the antenna is operable for receiving the radio signals and outputting first signals. The first connection part electrically connected to the low noise amplifier device and an electronic device is operable for transmitting power provided by the electronic device to the low noise amplifier device. The second connection part electrically connected to the low noise amplifier device and the electronic device is operable for transmitting the first signal to the electronic device.

An electronic device using an external antenna device according to one aspect of the invention comprises a main body and an antenna device. The main body comprises a first socket and a second socket. The antenna device having a connector device for connecting to the main body comprises an antenna, a low noise amplifier device, a first connection part and a second connection part. The antenna is operable for receiving a radio signal. The low noise amplifier device electrically connected to the antenna is operable for receiving the radio signal from the antenna and outputting a first signal. The first connection part electrically connected to the first socket is operable to transmit power provided by the electronic device to the low noise amplifier device. The second connection part electrically connected to the second socket is operable to transmit the first signal to the electronic device.

### BRIEF DESCRIPTION OF THE DRAWINGS

FIG. 1A is a schematic diagram illustrating an electronic device using a passive antenna.

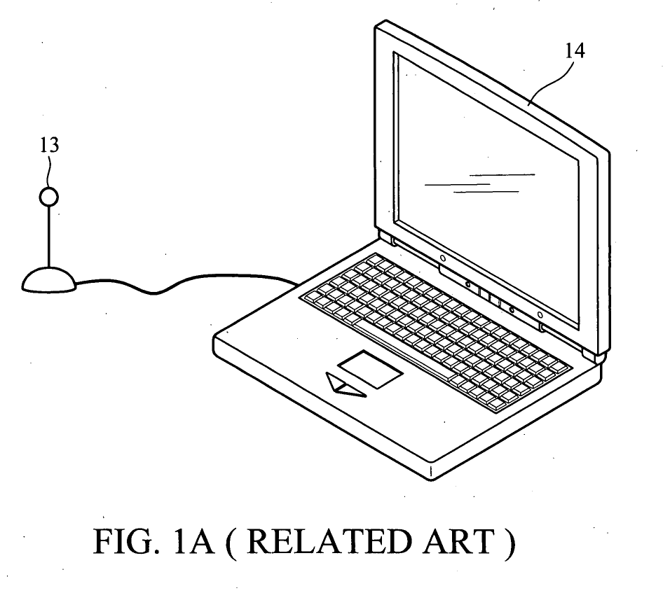

FIG. 1B is a schematic diagram illustrating an electronic device using an active antenna.

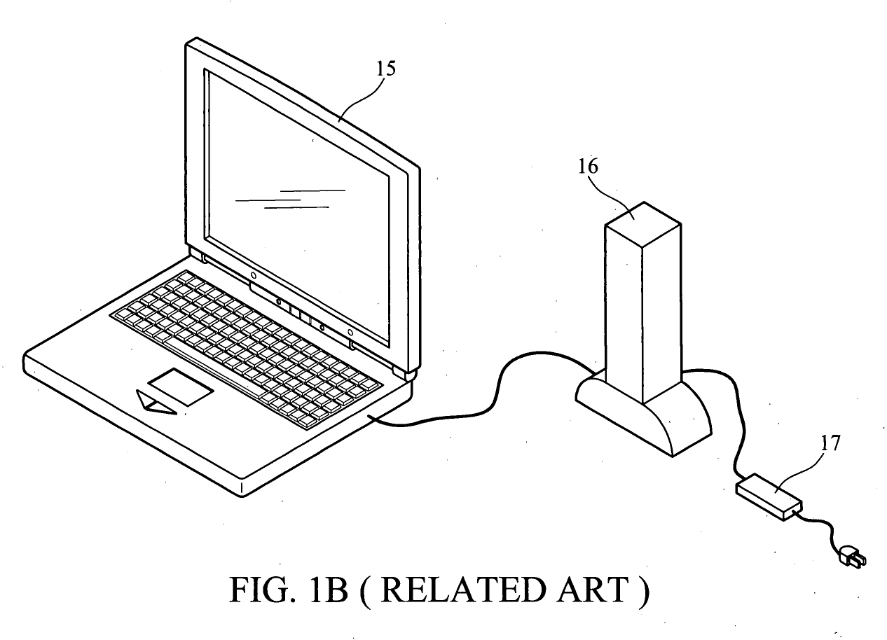

FIG. 2 is a schematic block diagram of an embodiment of an external antenna device for an electronic device.

FIG. 3 is a schematic diagram of an electronic device using an embodiment of an external antenna of FIG. 2.

FIG. 4 is a schematic block diagram of an external TV antenna 40b for a notebook computer 40a according to another aspect of the invention.

### DETAILED DESCRIPTION

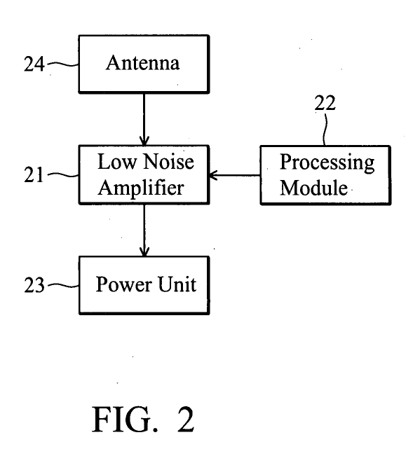

FIG. 2 is a schematic block diagram of an embodiment of an external antenna device for an electronic device. The low noise amplifier 21 works in response to the power provided by the power unit 23 to filter and amplify the signals received from the antenna 24 and outputs first signals. The processing module 22 disposed in an electronic device receives and processes the first signals.

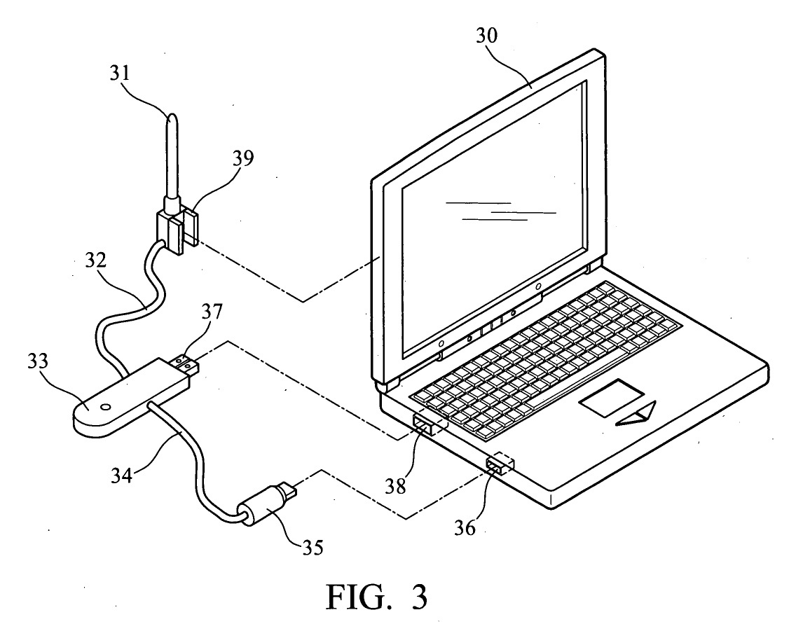

FIG. 3 shows a schematic diagram of an embodiment of an electronic device using an external antenna of FIG. 2. The antenna 31 having a connection device 39, such as a clip device, for connecting to an electronic device, preferably a notebook computer 30, is operable to receive radio signals. The antenna 31 is electrically connected to a low noise amplifier device 33 via a first signal cable 32, wherein the first signal cable 32 comprises at least two signal lines for transmitting the radio signals and ground. The low noise amplifier device 33 has a first connection part, such as a USB connector 37, to connect to a first socket, such as a USB port 38, for receiving the power provided by the notebook computer 30, wherein the first connection part is mounted on the low noise amplifier device 33. The low noise amplifier device 33 comprises a low noise amplifier unit working in response to the power transmitted from the notebook computer 30 to filter and amplify the signals received from the antenna 31 via the first signal cable 32 and then output first signals. The low noise amplifier device 33 is further connected to a second connection part such as a tuner connector 35 by a second signal cable 34 to connect to the second socket such as a tuner socket 36 disposed on the notebook computer 30, wherein the second signal cable 32 comprises at least two signal lines for transmitting the first signals and ground.

According to the embodiment illustrated in FIG. 3, the antenna 31 can be changed to an active antenna and the power the active antenna requires can be provided by the notebook computer 30. The notebook computer 30 provides the power to the low noise amplifier device 33 through the USB socket 38 as long as the USB connector 37 is inserted into the USB socket 38 and the active antenna 31 receives the power via the first signal cable 32 coupling between the antenna 31 and the low noise amplifier device 33. When the antenna 31 is changed to an active antenna, the first signal cable 32 either adds at least one signal line, except the two original signal lines for transmitting the power, or is designed to transmit power signals and antenna signals on distinct frequency domains so that both can be transmitted on the same signal line. When the antenna 31 comprises antenna units, the first signal cable 32 either adds at least one signal line, except the two original signal lines for transmitting another radio signal or is designed to transmit two distinct antenna signals transmit in different frequency domains so that both can be transmitted in the same signal line. When the antenna device 31 comprises at least two antenna units, the quality of radio signal receiving will be improved.

Although the embodiment illustrated in FIG. 3 offers a low noise amplifier device 33 with an USB connector 37 as an example, it is to be understood that the invention is not limited thereto. The USB connector 37 can be substituted with any connector, such as an IEEE 1394 connector, a PS/2 connector, as long as the notebook computer provides the corresponding port.

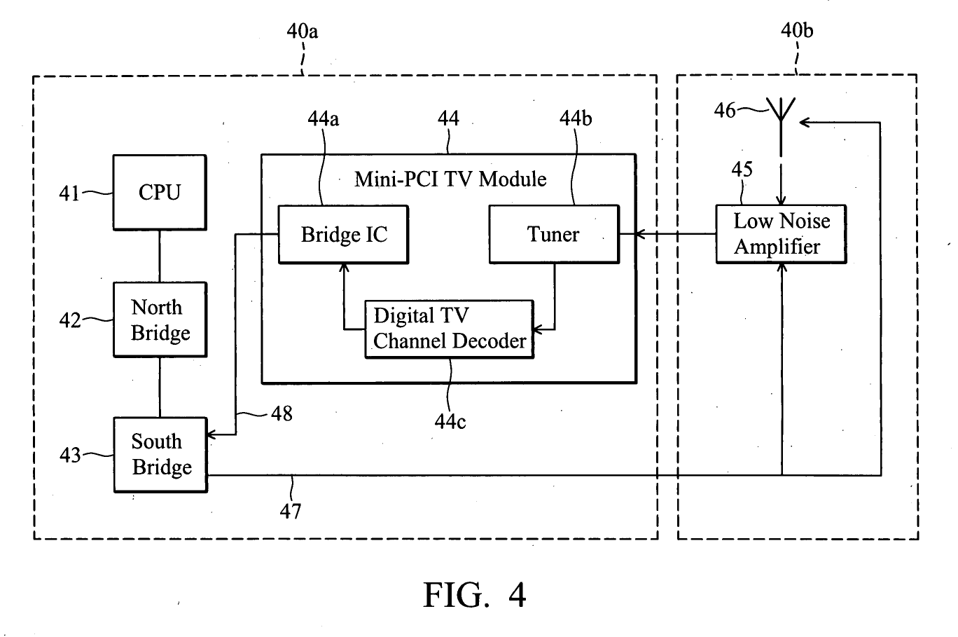

FIG. 4 is a schematic block diagram of an external TV antenna 40b for a notebook computer 40a according to another aspect of the invention. The South Bridge 43 provides USB power 47 and receives PCI signals 48 transmitted from a Mini-PCI TV processing module 44. The antenna 46 receives a digital-TV radio signal and transmits it to a low noise amplifier 45. The low noise amplifier 45 filters and amplifies the digital-TV radio signal and outputs a first signal. The Mini-PCI TV processing module 44 receives and transmits the first signal through a tuner 44b to the digital-TV Channel Decoder 44c for decoding. The digital-TV Channel Decoder 44c decodes the first signal and then outputs a transport stream to a bridge IC 44a. The bridge IC 44a, operable to transform signals into PCI signals, transforms the transport stream into a PCI signal. The bridge IC 44a outputs the PCI signal to the South Bridge 43. The South Bridge 43 processes the PCI signal with the North Bridge 42 and CPU 41 so that the notebook computer 40a can receive digital-TV.

While the invention has been described by way of example and in terms of preferred embodiment, it is to be understood that the invention is not limited thereto. To the contrary, it is intended to cover various modifications and (as would be apparent to those skilled in the art). Therefore, the scope of the appended claims should be accorded the broadest interpretation so as to encompass all such modifications.

What is claimed is:

1. An external antenna device, comprising:
an antenna for receiving a radio signal;
a low noise amplifier device electrically connected to the antenna for receiving the radio signal from the antenna and outputting a first signal;
a first connection part electrically connected to the low noise amplifier device and an electronic device for transmitting power provided by the electronic device to the low noise amplifier device; and
a second connection part electrically connected to the low noise amplifier device and the electronic device for transmitting the first signal to the electronic device.

2. The external antenna device as claimed in claim 1, further comprising:
a first signal cable electrically connected between the antenna and the low noise amplifier device; and
a second signal cable electrically connected between the low noise amplifier device and the second connection part.

3. The external antenna device as claimed in claim 2, wherein the first signal cable comprises at least two signal lines for transmitting the radio signal and ground.

4. The external antenna device as claimed in claim 2, wherein the second signal cable comprises at least two signal lines for transmitting the first signal and ground.

5. The external antenna device as claimed in claim 1, wherein the antenna is a passive antenna or an active antenna.

6. The external antenna device as claimed in claim 1, further comprising a connection device for connecting to the electronic device.

7. The external antenna device as claimed in claim 6, wherein the connecting device is a clip device.

8. The external antenna device as claimed in claim 1, wherein the second connection part is a tuner connector.

9. The external antenna device as claimed in claim 1, wherein the first connection part is an USB connector or an IEEE 1394 connector.

10. The external antenna device as claimed in claim 1, wherein the first connection part is mounted on the low noise amplifier device.

11. The external antenna as claimed in claim 1, wherein the antenna comprises one or more antenna units.

12. An electronic device using an external antenna device, comprising:
a main body, comprising:
a first socket; and
a second socket; and
an antenna device having a connection device for connecting to the main body, comprising:
an antenna for receiving a radio signal;
a low noise amplifier device electrically connected to the antenna for receiving the radio signal from the antenna and outputting a first signal;
a first connection part electrically connected to the first socket for transmitting power provided by the electronic device to the low noise amplifier device; and
a second connection part electrically connected to the second socket for transmitting the first signal to the electronic device.

13. The electronic device as claimed in claim 12, wherein the connecting device is a clip device.

14. The electronic device as claimed in claim 12, wherein the first connection part is USB connector or IEEE 1394 connector.

15. The electronic device claimed in claim 12, wherein the second connection part is a tuner connector.

16. The electronic device as claimed in claim 12, wherein the first connection part is disposed on the low noise amplifier device.

17. The electronic device as claimed in claim 12, wherein the first socket is USB socket or IEEE 1394 socket.

18. The electronic device as claimed in claim 12, wherein the second socket is a tuner socket.

19. The electronic device as claimed in claim 12, further comprising:
a first signal cable electrically connected between the antenna and the low noise amplifier device; and
a second signal cable electrically connected between the low noise amplifier device and the second connection part.

20. The electronic device as claimed in claim 19, wherein the antenna is a passive antenna or an active antenna.
